(19) United States
(12) Patent Application Publication
(10) Pub. No.: US 2010/0315388 A1
(43) Pub. Date: Dec. 16, 2010

(54) SOURCE DRIVER AND SERIAL-TO-PARALLEL DATA CONVERTING METHOD ADAPTED IN THE SOURCE DRIVER

(76) Inventors: Wen-Teng Fan, Sinshih Township (TW); Chien-Ru Chen, Sinshih Township (TW); Ying-Lieh Chen, Sinshih Township (TW); Chao-Ching Chi, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/483,153

(22) Filed: Jun. 11, 2009

(51) Int. Cl. G09G 5/00

(52) U.S. Cl. 345/204

(57) ABSTRACT

A source driver receiving data from an external bus is provided. The source driver comprises: a plurality of internal buses; a serial-to-parallel unit, a shift register and a plurality of channels. The serial-to-parallel unit is for receiving the data from the external bus and converting the data into plural display data for transmitting respectively on the internal buses in parallel; the shift register is for outputting shift control signals; and the plurality of channels are for latching data from the internal buses according to the shift control signals; wherein each shift control signal controls at least two channels that correspond respectively to the internal buses.

### BACKGROUND

1. Field of Invention

The present invention relates to a source driver. More particularly, the present invention relates to a source driver and a serial-to-parallel data converting method adapted in the source driver.

2. Description of Related Art

FIG. 1 illustrates a liquid crystal display device 1. The liquid crystal display comprises a source driver 10, a gate driver 12 and a pixel array 14. The source driver 10 shown in FIG. 1 comprises a shift register 100 and plural channels, each channel including a line buffer 102 (labeled as ‘B’ in the FIG. 1), a level shifter 104 (labeled as ‘L’) and a digital-to-analog converter (DAC) 106 (labeled as ‘D’). The line buffer 102 stores and outputs display data via a bus 11 by the control of the shift register 100. The level shifter 104 shifts voltage levels of the digital data signals 11. The DAC 106 generates a driving voltage to drive the pixels 108 of the pixel array 14 according to the outputted signals from the level shifter 104.

The liquid crystal display further comprises a timing controller for outputting display data to source driver 10 via the bus 11. The bus 11 includes at least one transmission line, connecting the timing controller and the source driver 10.

### SUMMARY

A source driver receiving data from an external bus is provided. The source driver comprises: a plurality of internal buses; a serial-to-parallel unit, a shift register and a plurality of channels. The serial-to-parallel unit is for receiving the data from the external bus and converting the data into plural display data for transmitting respectively on the internal buses in parallel; the shift register is for outputting shift control signals; and the plurality of channels are for latching data from the internal buses according to the shift control signals; wherein each shift control signal controls at least two channels that correspond respectively to the internal buses.

Another object is to provide a source driver, wherein the source driver receives data from an external bus. The source driver comprises a plurality of internal buses, a serial-to-parallel unit, a plurality of channel groups and a plurality of shift registers. The serial-to-parallel unit is for receiving a plurality data from the external bus, converting the plurality of data for transmitting on the internal buses. Each channel groups comprises a plurality of channels. Each of the plurality of shift registers is for outputting a group of shift control signals, wherein each of the channels latches a pixel from the internal buses according to the corresponding shift control signals, wherein each shift control signal controls at least two channels.

Yet another object of the present invention is to provide a serial-to-parallel data converting method adapted in a source driver comprising the steps of: receiving data from an external bus; converting the data for transmitting on the internal buses; outputting shift control signals; and latching pixel from the internal buses to a plurality of channel according to the shift control signals, wherein each shift control signal controls at least two channels.

Still another object of the present invention is to provide a serial-to-parallel data converting method adapted in a source driver comprising the steps of: receiving data from an external bus; converting the data for transmitting on the internal buses; outputting shift control signals; and latching pixel from the internal buses to a plurality of channel according to the shift control signals, wherein each shift control signal controls at least two channels.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram of a conventional liquid crystal display device;

FIG. 2 is a diagram of the source driver of an embodiment of the present invention;

FIG. 3 is a diagram of the source driver of another embodiment of the present invention;

FIG. 4 is a flow chart of the serial-to-parallel data converting method of yet another embodiment of the present invention;

FIG. 5 is a diagram of the source driver of still another embodiment of the present invention; and

FIG. 6 is a diagram of the source driver of further another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

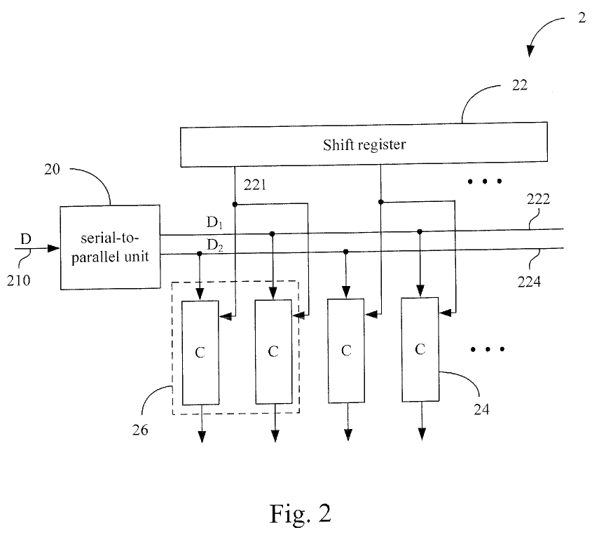

Please refer to FIG. 2, a diagram of the source driver 2 of an embodiment of the present invention. The source driver 2 comprises plural internal buses 222 and 224, a serial-to-parallel unit 20, a shift register 22 and a plurality of channels 24. The channels 24 are labeled ‘C’ in the FIG. 2. The number of the internal buses in this embodiment is two as an example, but not limited thereto. The serial-to-parallel unit 20 is connected to the external bus 210 for receiving the serial display data D. The serial-to-parallel unit 20 further converts the serial display data D to plural serial display data D1 and D2 for in parallel transmitting on the internal buses. The shift register 22 is for outputting shift control signals 221 for the channels 24 to latch data from the internal buses. In this embodiment, one external bus is converted into two internal buses, thus one shift control signal 221 controls two channels 24 each respectively latching data from the different internal buses. It should be noted that there may be more than one external bus, and there may be more than two internal buses.

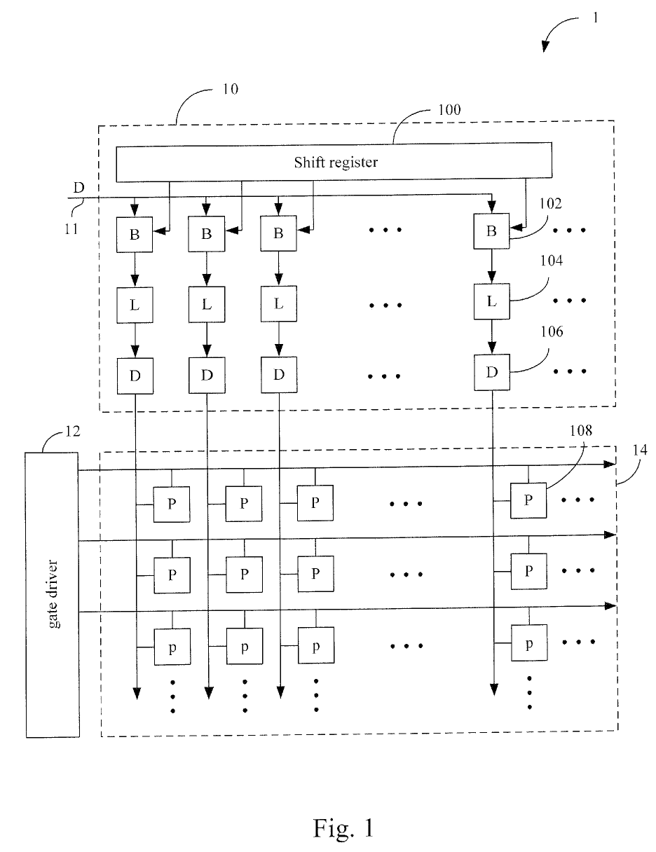

It is noticed that each channel 24 comprises a line buffer, a level shifter and a DAC, as depicted in FIG. 1. In order to simplify the drawing, the line buffer, the level shifter and the DAC is not shown in FIG. 2. In the present embodiment, the plurality of channels 24 are categorized as a plurality of channel groups 26, and each channel group is controlled by one corresponding shift control signal 221. In other words, when the display data D1 and D2 are sent out from the serial-to-parallel unit 20, the shift control signals 221 generated by the shift register 22 determine which channel 24 of the channel group 26 is supposed to receive the display data.

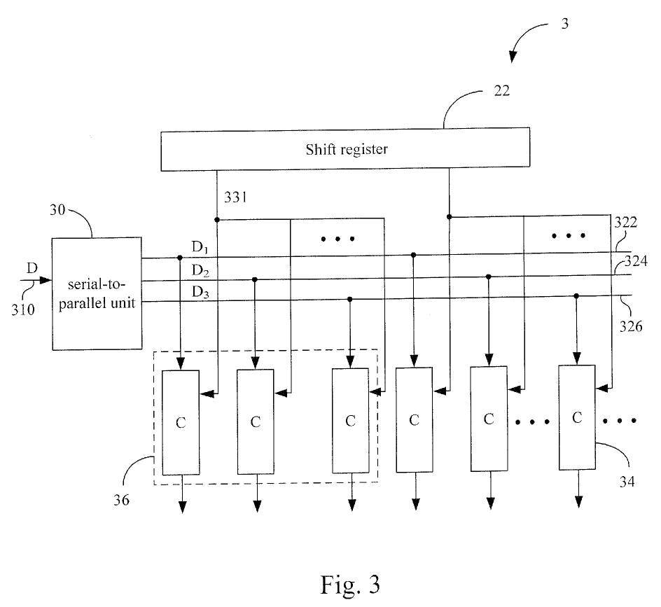

It is noticed that the number of the external buses, the number of the internal buses, the number of the shift control signals and the number of the channels of each channel group can be different in other embodiments. Those skilled in the art can easily make the modification. FIG. 3 is a diagram of the source driver 3 of an embodiment of the present invention. The source driver 3 in the present embodiment comprises more than two internal buses, a serial-to-parallel unit 30, a shift register 32 and a plurality of channels 34. The serial-to-parallel unit 30 is for receiving the display data D from the external bus 310 and further converts the display data D into display data D1, D2 and D3 for transmitting on the internal buses 322, 324, and 326, respectively, in parallel. The shift register 32 is for outputting shift control signals 321 and the plurality of channels 34 are for latching data from the display data D1, D2 and D3 on the internal buses 322, 324 and 326 according to the shift control signals 331. The channels 34 are categorized as a plurality of channel groups 26, and each channel group is controlled by one corresponding shift control signals 331. In the present embodiment, each channel group 36 comprises three channels, each specifically corresponding to the three internal buses respectively.

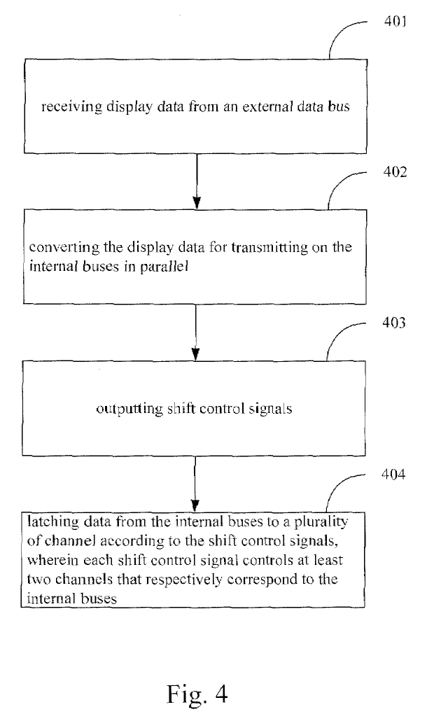

FIG. 4 is a flow chart of the transmission method of another embodiment of the present invention, adapted in a source driver, e.g. the source driver in FIG. 2 or FIG. 3. First in step 401, display data is received from an external bus. In step 402, the display data is converted for transmitting on the internal buses in parallel. And in step 403, the shift control signals are generated by the shift register. Then in step 404, data are latched from the internal buses to a plurality of channel according to the shift control signals.

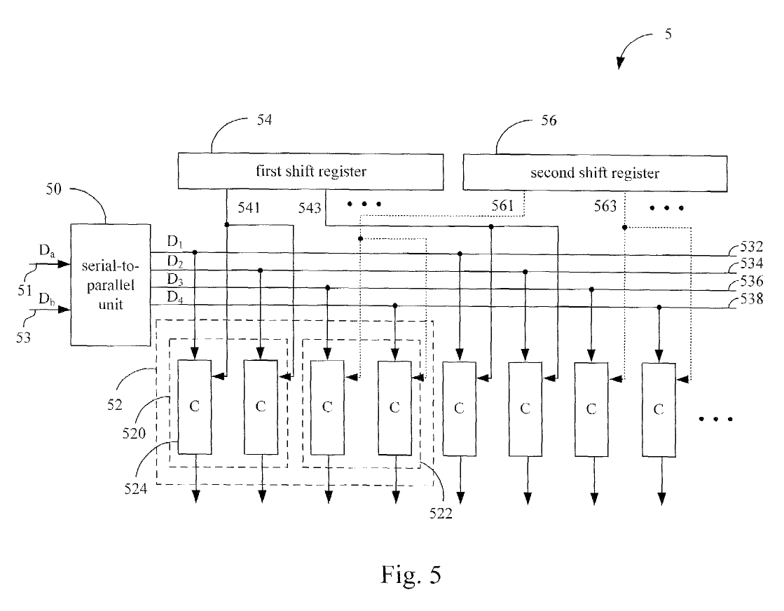

FIG. 5 illustrates a diagram of the source driver 5 of an embodiment of the present invention. The source driver 5 in the present embodiment comprises a plurality of external buses 51 and 53, a plurality of internal buses 532, 534, 536, and 538, a serial-to-parallel unit 50, a plurality of channel groups 52, a first shift register 54 and a second shift register 56. In the present embodiment, the serial-to-parallel unit 50 receives a first data Da and a second data Db respectively from the external buses 51 and 53, converts the first data Da and the second data Db into display data D1, D2, D3 and D4 for transmitting on the internal buses 532, 534, 536, and 538 in parallel.

Each channel groups 52 comprises a first channel subgroup 520 and a second channel subgroup 522. In the present embodiment, each channel subgroup comprises two channels 524. The first shift register 54 and the second shift register 56 outputs a group of first shift control signals and a group of second shift control signals respectively. In order to simplify the diagram, only the first shift control signals 541, 543 and second shift control signals 561, 563 are shown in FIG. 5. Each of the channels 542 latches data from the corresponding internal bus according to the corresponding shift control signals. For example, when the display data D1, D2, D3 and D4 are sent out from the serial-to-parallel unit 50, the first shift control signals 541 and the second shift control signals 561 are generated for each of the channels 524 of the first and the second channel subgroup 520 and 522 of the channel group 52 to latch data.

More specifically in the present embodiment, the first shift register 54 corresponds to the first external bus 51, and the second shift register 56 corresponds to the second external bus 53; the first data Da is converted to the display data D1 and D2, and the second data Db is converted to the display data D3 and D4. Therefore, the channels 524 correspond to the internal buses 532 and 534 are controlled by the first shift register 54, and the channels 524 correspond to the internal buses 536 and 538 are controlled by the second shift register 56.

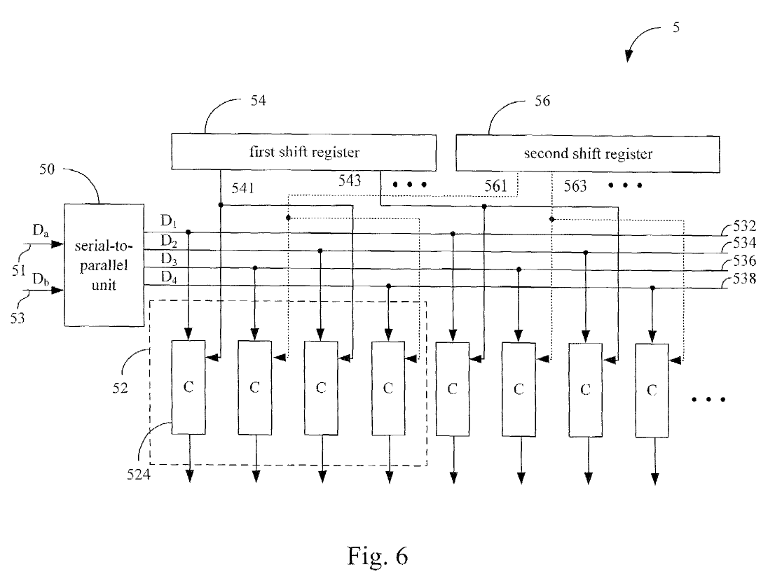

FIG. 6 illustrates a diagram of a source driver according another embodiment of the invention. The first shift register 54 corresponds to the first external bus 51, and the second shift register 56 corresponds to the second external bus 53; the first data Da is converted to the display data D1 and D3, and the second data Db is converted to the display data D2 and D4. Therefore, the channels 524 correspond to the internal buses 532 and 536 are controlled by the first shift register 54, and the channels 524 correspond to the internal buses 534 and 538 are controlled by the second shift register 56.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A source driver receiving data from an external bus, comprising:
a plurality of internal buses;
a serial-to-parallel unit for receiving the data from the external bus, converting the data into plural display data for transmitting respectively on the internal buses in parallel;
a shift register for outputting shift control signals; and
a plurality of channels, latching data from the internal buses according to the shift control signals;
wherein each shift control signal controls at least two channels that correspond respectively to the internal buses.

2. The source driver of claim 1, wherein each shift control signal controls a number of the channels and the number of the channels is equal to a number of the internal buses.

3. The source driver of claim 1, wherein the plurality of channels are categorized as a plurality of channel groups.

4. The source driver of claim 3, wherein each of the shift control signals is corresponding to a channel group.

5. A source driver receiving data from a plurality of external bus, comprising:
a plurality of internal buses, wherein a number of the external buses is different from a number of the internal buses;
a serial-to-parallel unit for receiving the data from the external bus, converting the data into plural display data for transmitting on the internal buses in parallel;
a plurality of channels; and
a plurality of shift registers each for outputting shift control signals for the channels to latch the display data from the internal buses;
wherein each shift control signal controls a number of channels which respectively correspond to internal buses.

6. The source driver of claim 5, wherein a number of the shift registers equal to a number of external buses.

7. The source driver of claim 5, wherein the shift registers comprises a first shift register outputting first shift control signals, and a second shift register outputting second shift control signals;
wherein the plurality of channels are categorized as a plurality of channel groups, each channel group comprising a first channel subgroup and a second channel subgroup each comprising a plurality of channels.

8. The source driver of claim 7, wherein each of the channels in the first and the second channel subgroup in a channel group latches the display data from the corresponding internal buses according to the first shift control signals and the second shift control signals respectively.
